(19) United States
(12) Patent Application Publication
(10) Pub. No.: US 2020/0231769 A1
(43) Pub. Date: Jul. 23, 2020

(54) METALLIC POLYMER BONDING AND ARTICLES OF MANUFACTURE

(71) Applicant: ExxonMobil Research and Engineering Company, Annandale, NJ (US)

(72) Inventors: Ning Ma, Whitehouse Station, NJ (US); Neeraj S. Thirumalai, Easton, PA (US); Srinivasan Rajagopalan, Easton, PA (US); Jevan Furmanski, Califon, NJ (US)

(21) Appl. No.: 16/739,897

(22) Filed: Jan. 10, 2020

Related U.S. Application Data
(60) Provisional application No. 62/795,078, filed on Jan. 22, 2019.

(51) Int. Cl. C08J 5/12; B29C 65/00; B29C 65/48

(52) U.S. Cl. CPC C08J 5/12; B29C 66/341; B33Y 10/00; B29C 65/4805; B29C 66/41

(57) ABSTRACT

The present disclosure relates to metal/polymer hybrid materials, and methods for fabricating such, with strong bonding between the metals and polymers and improved properties. The articles of manufacture disclosed herein can include a metallic material and a polymer material bonded to the metallic material via a cocontinuous interface that provides for strong bonding between the metallic material and the polymer material.

### CROSS-REFERENCE TO RELATED APPLICATIONS

This application claims the benefit of U.S. Provisional Application No. 62/795,078, filed on Jan. 22, 2019, the entire contents of which are incorporated herein by reference.

### FIELD

The present disclosure relates to fabricating metal/polymer hybrid materials with strong bonding between the metals and polymers and improved properties.

### DESCRIPTION

Metals and polymers are common structural materials and have quite a few differences in physical nature and material behavior. For example, metals are strong, stiff, electrically and thermally conductive, and not permeable by gas. But metals are heavy and susceptible to environmental attack. On the other hand, polymers are light, tough, and inert to most chemical environments, while polymers tend to have low strength and elastic modulus and poor thermal and electrical conductivity.

Current methods to bond a polymeric material and a metallic material use epoxy glue and mechanical coupling. The bonding is usually developed under cool conditions. Therefore, there is a macroscopically continuous and distinguishable interface between two materials. The interface is a weak link and it tends to have low cohesive strength and be degraded during service.

There is a need in the art for improved materials and methods for fabricating metal/polymer hybrid materials with strong bonding between the metals and polymers and a range of mechanical properties or functionalities that cannot be achieved in with metals or polymers alone. The present disclosure provides a solution for this need.

### SUMMARY

An article of manufacture can include a metallic material and a polymer material bonded to the metallic material, wherein the bond comprises a cocontinuous interface that provides an inter-connection interface between the metallic material and the polymer material. The metallic material can be bonded directly to the polymer material. In certain embodiments, the metallic material and the polymer material have similar melting temperatures. For example, the metallic material can include Al-Si and the polymer material can include polyether ether ketone (“PEEK”). The metallic material can include any Si containing alloy in certain embodiments. Any other suitable materials are contemplated herein.

In certain embodiments, the article can include a buffer layer such that the metallic material is bonded to the buffer layer on a first side of the buffer layer and the polymer material is bonded to the buffer layer on a second side of the buffer layer. For example, the metallic material can be aluminum and the buffer layer can be a matrix of metal and polymer material, where the metallic material is in the form of particles and the polymer material is the matrix. The shape and size of metallic material particles in the buffer layer can be designed to maximize its contacting area with polymer material in the buffer layer. The surface of the metallic material can be coated with polymeric coating to enhance the cohesion with polymer material in the buffer layer.

The metallic material can comprise Si and the polymer can be PEEK with carbon filler. In certain embodiments, this can allow SiC to be formed in the cocontinuous interface.

In certain embodiments, the cocontinuous interface can include agglomerated metal particles forming a network of connected metal particles. Any other suitable cocontinuous interface is contemplated herein.

A method can include bonding a metallic material and a polymer material together to create a cocontinuous interface. Bonding can include directly joining the metallic material and the polymer material together. For example, the metallic material and the polymer material can include melting temperatures (e.g., using ASTM E794 or any other suitable method) within about 500° C., 300° C., 200° C., 150° C., 100° C., 75° C., or 50° C. of each other. Any other suitable melting point difference to allow the polymer material to be joined together with the metallic material is contemplated herein.

Bonding the metallic material and the polymer material together can include joining the metallic material to a buffer layer on a first side of the buffer layer, and joining the polymer material to the buffer layer on a second side of the buffer layer. The buffer layer can have a melting temperature that is between the melting temperature of the metallic material and the melting temperature polymer material, and have good cohesion with both the metallic material and the polymer material. The order of joining can be in any order.

Joining the buffer layer can include causing the metallic material to form agglomerated particles in a network to form the cocontinuous interface. In certain embodiments, the method can include forming SiC within the cocontinuous interface.

Joining can include additive manufacturing methods. For example, additive manufacturing can include laser metal deposition or any other suitable method. Any other suitable manufacturing process to weld a polymer and a metal to create a cocontinuous interface layer is contemplated herein.

In certain embodiments, additive manufacturing can include mixing a buffer material with the polymer material and additively manufacturing the mixture to create a polymer transition portion. Additive manufacturing can include mixing a buffer material with the metallic material and additively manufacturing the mixture to create a metal transition portion. The buffer material can have a melting temperature that is between the melting temperature of the polymer material and the melting temperature of the metallic material.

Additive manufacturing can include forming the polymer transition portion on the metal transition portion to create a buffer layer. Additive manufacturing can also include forming the metal transition portion on the polymer transition portion to create a buffer layer.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a cross-sectional view of an embodiment of an article of manufacture in accordance with this disclosure, shown diffuse at the interface;

FIG. 2 is a cross-sectional view of an embodiment of an article of manufacture in accordance with this disclosure;

FIGS. 3A-3D show an embodiment of a method in accordance with this disclosure;

FIGS. 4A-4D show an embodiment of a method in accordance with this disclosure;

FIG. 5 shows an embodiment of an additive manufacturing system in accordance with this disclosure; and

FIG. 6 shows two different 3D images of embodiments of a cocontinuous interface in accordance with this disclosure.

### DETAILED DESCRIPTION

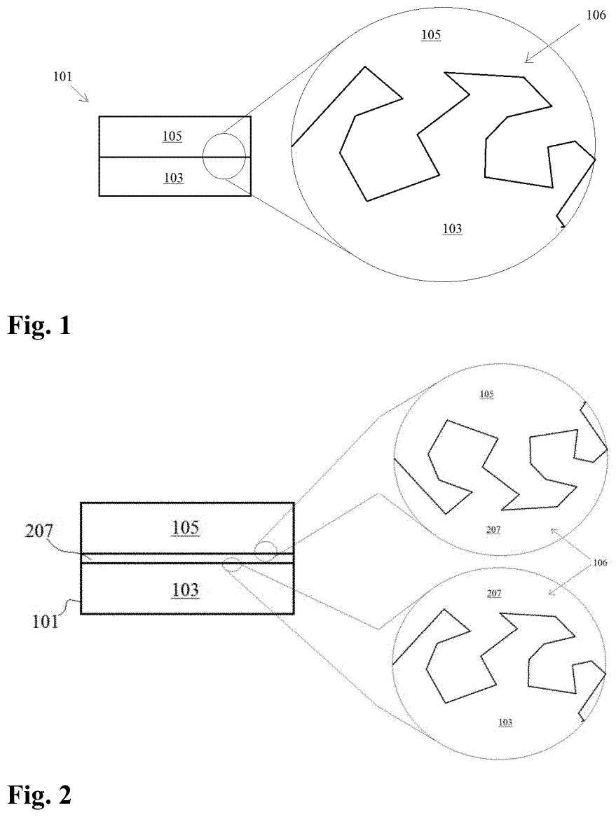

Reference will now be made to the drawings wherein like reference numerals identify similar structural features or aspects of the subject disclosure. An schematic view of an embodiment of an article of manufacture in accordance with this disclosure is shown in FIG. 1 and is designated generally by reference character 101. The systems and methods described herein can be used to join a polymer material and a metallic material, for example, and to create any suitable article of manufacture as disclosed herein. Articles of manufacture can be for any suitable use or application.

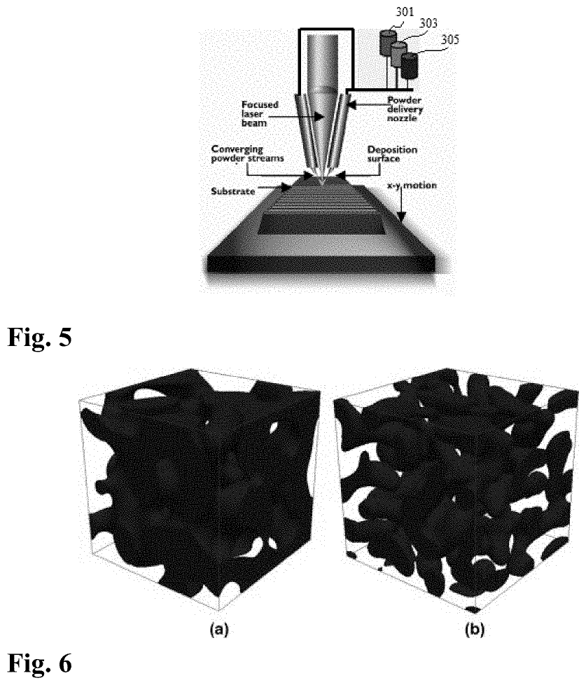

Referring to FIG. 1, an article of manufacture 101 can include a metallic material 105 and a polymer material 103 bonded to the metallic material 105 with a cocontinuous interface 106 (e.g., which can be created as a result of two molten materials interacting). A cocontinuous interface is defined herein as an interface between the metallic material and the polymer material such that both phases interpenetrate, e.g., both phases penetrate reciprocally. The cocontinuous interface can include inter-atomic bonds across the interface, e.g., it can include at least one of van der Waals, ionic, and/or covalent bonds. The interpenetrations can have an average length from the base of the material to the tip of the interpenetration of from about 10 um to 1 mm. Two different 3D images of embodiments of a cocontinuous interface are shown in FIG. 6.

As shown in FIG. 1, the metallic material 105 can be welded, or otherwise joined, directly to the polymer material 103. For example, the metallic material 105 can include Al—Mg—Cu and the polymer material 103 can include a high temperature polymer (e.g., PEEK due to similar melting temperatures to Al—Mg—Cu). Both Al—Mg—Cu and the polymer material PEEK can be melted and processed at 400 degree C. Any other suitable materials are contemplated herein, e.g., Al—Si.

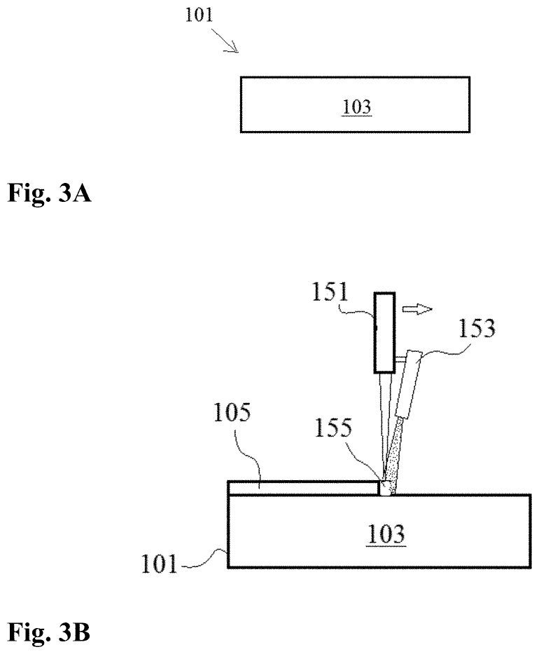

Referring to FIG. 2, in certain embodiments, the article 101 can include a buffer layer 207 such that the metallic material 105 is joined to the buffer layer 207 on a first side of the buffer layer 207 via a cocontinuous interface and the polymer material 103 is joined to the buffer layer 207 via a cocontinuous interface on a second side of the buffer layer 207. The buffer layer 207 can comprise metallic particles mixed in a polymer material matrix. The shape and size of metallic particles in the buffer layer can be designed to maximize its contacting area with polymer material in the buffer layer. The shape of metallic particles can be elongated with rough surface finishing, or another suitable method. The surface of the metallic material can be coated with polymeric coating to enhance the cohesion with polymer material in the buffer layer. For example, the metallic material 105 can be aluminum and the buffer layer 207 can be a uniform mixture of metal and polymer material, where metallic material are in the form of particles and polymer material is the matrix (e.g., a polyamide-metal mixture, e.g., alumide, which comprises nylon filled with aluminum powder). The metallic material can include any Si or Al containing alloy in certain embodiments.

The buffer layer 207 can comprise a low melting alloy (also known as fusible alloys), e.g., a eutectic alloy with a melting temperature similar to a polymer. In certain embodiments, the buffer layer 207 comprises a low melting eutectic alloy having a melting temperature measured according to ASTM E794 of from about 150 to 200° C. In other embodiments, the buffer layer can comprise a thermoplastic material, such as PEEK or polyimide. The thermoplastic material can have a melting temperature measured according to ASTM E794 of less than 400° C., such as between about 100° C. and 400° C. Any other suitable materials can be used.

The shape and size of the metallic particles in the buffer layer can be designed to maximize the particles' contacting area with polymer material in the buffer layer. The surface of the metallic material can also be coated with polymeric coating to enhance the cohesion with the polymer material in the buffer layer. In certain embodiments, the thickness of the buffer layer 207 can be less than about 5 mm, 4, mm, 3 mm, 2 mm, 1 mm, or 0.5 mm. In certain embodiments, the buffer layer 207 can have a minimum thickness of about 0.025 mm, 0.05 mm, 0.1 mm, or 0.2 mm and a maximum thickness of 5 mm, 3 mm, 2 mm, or 1 mm, including any combination of minimum and maximum values recited herein. Embodiments herein could also include two or more buffer layers.

In certain embodiments, the metallic material 105 can be Si or Al containing alloy and the polymer material 103 can be PEEK with carbon filler. In certain embodiments, this can allow SiC to be formed in the cocontinuous interface 106. SiC, for example, can be used as the ingredient of carbon fiber which has up to 800 ksi strength and good cohesion with both metallic and polymer materials.

In certain embodiments, the interface structure 106 can include agglomerated metal particles forming a network of connected metal particles. Any other suitable cocontinuous interface 106 is contemplated herein.

In certain embodiments, the tensile strength of the article may be greater than the tensile strength of the polymer material and/or the metallic material, wherein tensile strength is measured according to ASTM E8

A fabrication method can include joining a metallic material 105 and a polymer material 103 together to create a cocontinuous interface 106. Joining can include additive manufacturing. For example, additive manufacturing can include laser metal deposition or any other suitable method. Any other suitable manufacturing process to join or weld a polymer and a metal to create a cocontinuous interface 106 is contemplated herein.

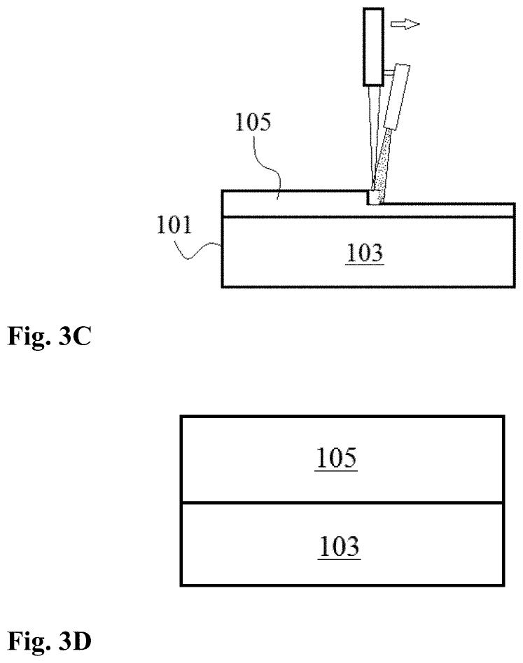

Referring to FIGS. 3A-3D, joining can include directly joining the metallic material 105 and the polymer material 103 together. The metallic material 105 and the polymer material 103 can be selected to have melting temperatures within about 500° C., 300° C., 200° C., 150° C., 100° C., 75° C., or 50° C. of each other. As shown in FIG. 3A, the article 101 can start with polymer material 103 in a layer or layers (which can be additively manufactured or created in any other suitable manner). The metallic material 105 can be additively manufactured onto the polymer material 103 in a first layer (FIG. 3B) and then a second layer (FIG. 3C, and optionally multiple layers, to form the article 101 shown in FIG. 3D. A suitable LMD system for such can include at least one powder nozzle 151 and at least one energy applicator 153 (e.g., a laser) to form a melt pool 155 of metallic material 105. The method can be reversed such that the metallic material 105 forms the base layer and then the polymer material 105 is additively manufactured thereon.

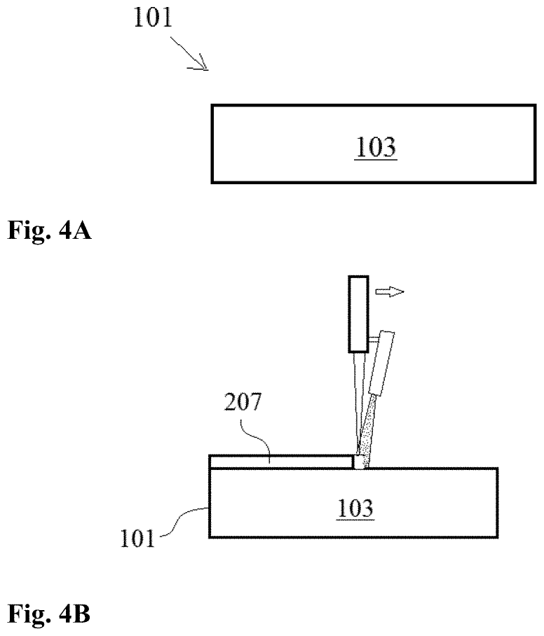

Joining the metallic material and the polymer material together can include starting with a polymer material 103 (FIG. 4A), and then joining a buffer layer 207 to the polymer material 103 (FIG. 4B). The buffer layer 207 can have a melting temperature between the melting temperature of the metallic material 105 and the melting temperature of the polymer material 103, which enables good cohesion for both the metallic material 105 and the polymer material 103 with the buffer layer 207. The metallic material 105 can then be joined to the buffer layer 207 (FIG. 4C) to create the article 101 in FIG. 4D. The order of joining can be in any order. For example, the method can be reversed such that the metallic material 105 forms the base layer 101.

Joining the buffer layer 207 can include causing the metallic material 105 to form agglomerated particles in a network. In certain embodiments, the method can include forming SiC within the cocontinuous interface.

In certain embodiments, additive manufacturing can include mixing a buffer material with the polymer material 103 and additively manufacturing the mixture to create a polymer transition portion (not specifically shown in the figures, but on the polymer side of the buffer layer 207 such that the buffer layer 207 includes a graded composition from the polymer material 103 to the buffer material of the buffer layer 207). Additive manufacturing can also or alternatively include mixing a buffer material with the metallic material 105 and additively manufacturing the mixture to create a metal transition portion (not specifically shown in the figures, but on the metal side of the buffer layer 207 such that the buffer layer 207 includes a graded composition from the metallic material 105 to the buffer material of the buffer layer 207).

In certain embodiments, additive manufacturing can include forming the polymer transition portion directly on the metal transition portion to create the buffer layer 207. Additive manufacturing can also include forming the metal transition portion on the polymer transition portion to create the buffer layer 207. Any other suitable method is contemplated herein, and any suitable thickness and/or composition for the buffer layer 207 is contemplated herein.

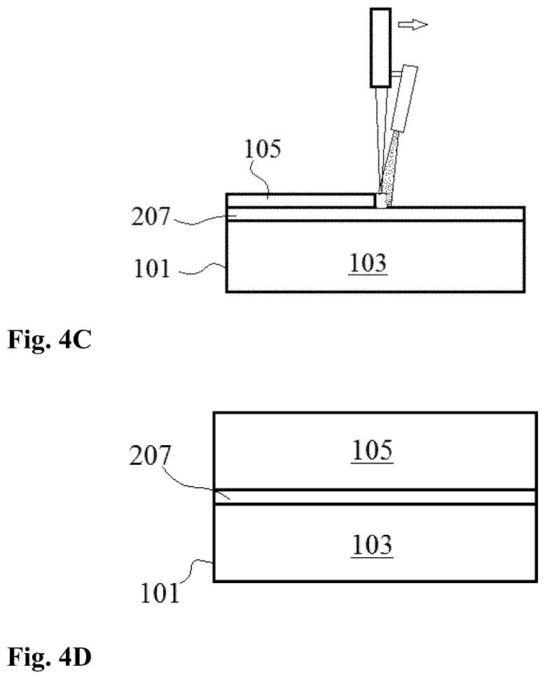

The article 101 can be manufactured in any suitable manner (e.g., additively manufactured, cast), including by use of the apparatus shown in FIG. 5. For example, the article 101 can be formed in a single additive manufacturing procedure using a machine having the ability to selectively deposit multiple materials (e.g., as shown in FIG. 5 having separate powder material reservoirs 301, 303, and 305 in powder flow communication with the powder delivery nozzle).

In certain embodiments, the fabrication method uses additive manufacturing techniques such as laser metal deposition (LMD), or any other suitable method (e.g., powder bed fusion, electron beam welding).

The melting temperature of a polymer is usually below 200° C., but the melting temperature of metallic materials is usually substantially higher. For example, certain kinds of steel melt at about 1500° C. In prior methods, liquid steel would easily vaporize or carbonize polymer, thus no bonding would be formed. Certain embodiments disclosed herein, such as those using a buffer layer between polymer and metal can eliminate this problem. There are a number of low melting eutectic alloys that are suitable for use herein, such as 48Bi28Pb14Sn9Sb with a melting temperature of about 150° C. to about 200° C., which is comparable to many commodity thermoplastics.

Certain embodiments can use high temperature thermoplastics, such as PEEK and polyimide. The melting temperature of the high temperature thermoplastics can be as high as 400° C., which is at the melting temperature of an Al—Mg—Cu eutectic alloy. Embodiments can form a network of metallic particles that are joined or welded to one another in a continuous network.

Embodiments can use a polyamide and metal mixture buffer layer between polymer and metals. For example, alumide is an example material used in additive manufacturing that comprises nylon filled with aluminum powder, which can be printed layer by layer. It can withstand much higher thermal loads, and thus can survive the metallic additive process. Alumide has good cohesion with both metallic material and polymer material.

Embodiments of the methods disclosed herein cause in-situ SiC formation using high Si containing metallic alloys and high heat input. Si is a common alloying element in metallic alloys, such as in commercial Al4047, which has about 10 wt % Si to about 12 wt % Si.

Embodiments can also allow fabrication of metal/polymer composite materials with any desired geometry. Example compositions of certain embodiments of articles of manufacture include, e.g., aluminum/alumide/polymer composite, Al—Si/PEEK (and heat treated), Al—Si/PEEK+carbon filler (and heat treated).

Embodiments of articles of manufacture can include any suitable equipment and/or structures used in oil and gas or other operations (e.g., tanks or containers or other equipment used in petrochemical processes, pipelines, tools, etc.), or any other suitable article of manufacture. The advantages of metal/polymer composite articles can include lighter weight articles and improved corrosion resistance, erosion resistance, and/or thermal insulation properties. In many applications, it is desired to have a metal/polymer composite with a range of mechanical properties and/or functionalities which could not be achieved in a component with metals or polymers alone, and embodiments herein can satisfy such desire.

Embodiments disclosed herein enable a strong bond to be formed between metallic and polymer materials via the cocontinuous interface. In contrast, conventional methods can cause macroscopically continuous and distinguishable interfaces in composite articles of manufacture.

As will be appreciated by those skilled in the art, certain aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Any suitable combination(s) of any disclosed embodiments and/or any suitable portion(s) thereof is contemplated therein as appreciated by those having ordinary skill in the art.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

1. An article comprising:
i) a metallic material, and
ii) a polymer material bonded to the metallic material, wherein the bond comprises a cocontinuous interface between the metallic material and the polymer material.

2. The article of claim 1, wherein the metallic material is bonded directly to the polymer material with the cocontinuous interface.

3. The article of claim 1, wherein the melting temperature of the metallic material and the melting temperature of the polymer material, measured according to ASTM E794, are within about 100° C.

4. The article of claim 1, further comprising a buffer layer between the metallic material and the polymer material.

5. The article of claim 4, wherein the buffer layer material comprises metallic particles within a polymer material matrix.

6. The article of claim 4, wherein the metallic material comprises aluminum and the buffer layer comprises alumide.

7. The article of claim 1, further comprising SiC in the cocontinuous interface.

8. The article of claim 1, wherein the metallic material is any Si containing alloy.

9. The article of claim 1, wherein the cocontinuous interface includes agglomerated metal particles forming a network of connected metal particles.

10. The article of claim 1, wherein the tensile strength of the article is greater than the tensile strength of the polymer material, wherein tensile strength is measured according to ASTM E8.

11. The article of claim 1, wherein the tensile strength of the article is greater than the tensile strength of the metallic material, wherein tensile strength is measured according to ASTM E8.

12. The article of claim 1, wherein the cocontinuous interface comprises interpenetrations having an average length from the base of the material to the tip of the interpenetration of from about 10 um to 1 mm.

13. A manufacturing method, comprising joining a metallic material and a polymer material together to create a cocontinuous interface between the metallic material and the polymer material.

14. The method of claim 13, wherein joining includes directly joining the metallic material and the polymer material together, wherein the metallic material and the polymer material have a melting temperature, measured according to ASTM E794, within about 100° C. of each other.

15. The method of claim 13, wherein joining the metallic material and the polymer material together includes joining the metallic material to a buffer layer on a first side of the buffer layer, and joining the polymer material to the buffer layer on a second side of the buffer layer, wherein the buffer layer has a melting temperature, measured according to ASTM E794, between the melting temperature of the metallic material and the melting temperature of the polymer material.

16. The method of claim 15, wherein the buffer material comprises metallic particles in a polymer material matrix.

17. The method of claim 15, wherein joining the buffer layer causes the metallic material to form agglomerated particles within the cocontinuous interface.

18. The method of claim 13, wherein SiC forms within the cocontinuous interface.

19. The method of claim 13, wherein the joining includes additive manufacturing.

20. The method of claim 19, wherein the additive manufacturing includes laser metal deposition.

21. The method of claim 19, wherein the additive manufacturing includes mixing a buffer material with the polymer material and additively manufacturing the mixture to create a polymer transition portion.

22. The method of claim 19, wherein the additive manufacturing includes mixing a buffer material with the metallic material and additively manufacturing the mixture to create a metal transition portion.
